(19) United States
(12) Patent Application Publication
(10) Pub. No.: US 2026/0308959 A1
(43) Pub. Date: Oct. 8, 2026

(54) DOOR-IN-DOOR REFRIGERATOR

(71) Applicants: QINGDAO HAIER REFRIGERATOR CO.,LTD, Qingdao (CN); HAIER SMART HOME CO.,LTD, Qingdao (CN)

(72) Inventors: Peng LV, Qingdao (CN); Hao ZHANG, Qingdao (CN)

(73) Assignees: QINGDAO HAIER REFRIGERATOR CO.,LTD, Qingdao (CN); HAIER SMART HOME CO.,LTD, Qingdao (CN)

(21) Appl. No.: 18/998,510

(22) PCT Filed: Jul. 19, 2023
(86) PCT No.: PCT/CN2023/108195

§ 371 Date: Jan. 26, 2025

(30) Foreign Application Priority Data
Jul. 29, 2022 (CN) 202210909177.8

(51) Int. Cl. E05D 11/00; E05D 7/00; F25D 23/02

(52) U.S. Cl. CPC E05D 11/0081; E05D 7/00; F25D 23/025; F25D 23/028; E05Y 2400/654; E05Y 2900/31; F25D 2323/024; F25D 2400/40

(57) ABSTRACT

A door-in-door refrigerator includes: a cabinet, provided with a cabinet opening and a control portion; a main door, disposed on the cabinet, to close or open the cabinet opening; a main door hinge, to rotatably connect the main door to the cabinet; a secondary door, disposed on the main door; a secondary door hinge, to rotatably connect the secondary door to the main door; and a wire harness, including a secondary door wire harness and a main door wire harness. The main door is provided with a main door electric component. The secondary door is provided with a secondary door electric component. The secondary door wire harness is employed to connect the secondary door electric component to the control portion and the main door wire harness is employed to connect the main door electric component to the control portion.

### CROSS-REFERENCE TO RELATED APPLICATIONS

This application is a continuation of International Application No. PCT/CN2023/108195, filed on Jul. 19, 2023, which claims priority to Chinese Patent Application No. CN202210909177.8, filed on Jul. 29, 2022. The disclosures of the above-mentioned applications are hereby incorporated by reference in their entireties.

### TECHNICAL FIELD

The present disclosure relates to the technical field of refrigerators, and more particularly to a door-in-door refrigerator.

### BACKGROUND

A refrigerator is a refrigeration apparatus capable of providing a constant low temperature and cold state for food and other items inside the refrigerator. Generally, the refrigerator comprises a cabinet and a door body disposed on the cabinet by a hinge. With the development of the economy, the door body has more and more functions, which means more and more electric appliances inside the door body. The electric appliances inside the door body are required to be connected to a controller located in the cabinet by wire harness to realize communication.

In related arts, the hinge has a connection cavity disposed inside, the wire harness is connected to the controller located in the cabinet through the connection cavity.

During the implementation of the embodiment of the present disclosure, at least the following problems are found in the related arts.

The door body of the refrigerator is developing towards multi-functional and thinning, but more and more electric appliances are provided inside the door body. However, the connection cavity is smaller and smaller because of the thinning of the door body. In a case where a large number of electric appliances are provided inside the door body, the connection cavity inside the hinge cannot receive all of the wire harnesses, and some of the wire harnesses are exposed to the outside and are very easy to wear.

### SUMMARY

A brief summary is given below to give a basic understanding of some aspects of the disclosed embodiments. The summary is not intended to be a general comment to identify crucial/essential constituent elements or to describe the protection scope of these embodiments but rather to serve as a preface to the detailed description that follows.

A door-in-door refrigerator provided by the embodiment of the present disclosure provides more space for receiving a wire harness, which avoids the wear of the wire harness caused by some of the wire harnesses being exposed to the outside.

In some embodiments, the door-in-door refrigerator comprises: a cabinet, provided with an cabinet opening and a control portion; a main door, disposed on the cabinet, employed to close or open the cabinet opening, where the main door is provided with a main door electric component; a main door hinge, employed to rotatably connect the main door to the cabinet; a secondary door, disposed on the main door, where the secondary door is provided with a secondary door electric component; a secondary door hinge, employed to rotatably connect the secondary door to the main door; and a wire harness, comprising a secondary door wire harness and a main door wire harness, where the secondary door wire harness is employed to connect the secondary door electric component to the control portion, and the main door wire harness is employed to connect the main door electric component to the control portion; where the secondary door wire harness passes through the main door hinge and the secondary door hinge, and the main door wire harness passes through the main door hinge.

Optionally, the secondary door wire harness passes through the secondary door hinge from bottom to top, passes into the main door from a top of the secondary door hinge, passes through the main door hinge from bottom to top, passes into the cabinet from a top of the main door hinge, and connects to the control portion; the main door wire harness passes through the main door hinge from bottom to top, passes into the cabinet from the top of the main door hinge, and connects to the control portion.

Optionally, the main door hinge comprises: a hinge plate, disposed on the cabinet, and where the hinge plate is provided with a first wire barrel for receiving the wire harness; a wire harness plate, provided with a second wire barrel for receiving the wire harness; and a hinge-track plate, disposed on the door body, where the hinge-track plate is provided with a hinge slot and a track slot, the hinge slot is employed to receive the first wire barrel, the track slot is employed to receive the second wire barrel, and the second wire barrel is moveable within the track slot; where the secondary door wire harness passes through the first wire barrel and/or the second wire barrel from bottom to top; and the main door wire harness passes through the first wire barrel and/or the second wire barrel from bottom to top.

Optionally, the track slot is in an arc shape, and the second wire barrel rotates around the first wire barrel as a rotation center and eccentrically rotates within the arc track slot; the secondary door wire harness and the main door wire harness are provided with a predetermined length L, and the predetermined length L is employed to avoid pulling the secondary door wire harness and the main door wire harness by rotating the main door.

Optionally, the predetermined length L is in a range of L≥πR*A/360, where R is defined as a distance between an axis of the first wire barrel and an axis of the second wire barrel, and A is defined as a maximum deflection angle of the second wire barrel.

Optionally, the secondary door hinge comprises: a hinge shaft, provided with one or more first communication connection ports on a surface of the hinge shaft; where the first communication connection port is connected to the secondary door electric component; and a hinge seat, provided with a recess, where the recess is adapted to receive the hinge shaft, and an inner wall of the recess is provided with one or more second communication connection ports; where the second communication connection port is electrically connected to a terminal located at an outer side of the hinge seat, and the second communication connection port corresponds to the first communication connection port one-to-one; where in a case where the hinge shaft is inserted into the recess, and the hinge shaft is relatively stationary or relatively rotated to the hinge seat, each first communication connection port is connected to the corresponding second communication connection port to realize communication.

Optionally, the secondary door wire harness comprises: a first sub-wire harness, employed to connect the first communication connection port to the secondary door electric component; and a second sub-wire harness, employed to connect the second communication connection port to the terminal located at the outer side of the hinge seat.

Optionally, the door-in-door refrigerator further comprises: a secondary door hinge box, disposed above the main door and rotatably connected to the secondary door, where the secondary door hinge is wrapped in the secondary door hinge box; and a main door hinge box, disposed above the cabinet and rotatably connected to the cabinet, where the main door hinge is wrapped in the main door hinge box.

Optionally, the secondary door wire harness passes from an upper portion of the secondary door hinge into the secondary door hinge box, passes from a lower portion of the secondary door hinge box into the main door, passes from the inner of the main door through the first wire barrel and/or the second wire barrel from bottom to top, passes from an upper portion of the main door hinge into the main door hinge box, and passes from a lower portion of the main door hinge box into the cabinet.

Optionally, the main door wire harness passes from the inner of the main door through the first wire barrel and/or the second wire barrel from bottom to top, passes from the upper portion of the main door hinge into the main door hinge box, thus passes from the lower portion of the main door hinge box into the cabinet.

The door-in-door refrigerator provided by the embodiment of the present disclosure can realize the following technical advantages.

The door-in-door refrigerator provided by the embodiment of the present disclosure can realize the rotatable connection between the main door and the cabinet by the main door hinge. The main door hinge is provided with the first wire barrel and the second wire barrel for receiving a wire harness, providing more arrangement space for the wire harness, and avoiding the wear of the wire harness caused by some of the wire harnesses exposed to the outside. Furthermore, the second wire barrel is disposed in the track slot and is moveable within the track slot, the main door can be opened at a large angle, and the second wire barrel rotates at a small angle. Therefore, the opening and closing of the main door causes less pulling on the wire harness passed through the second wire barrel, reducing the wear on the wire harness passed through the second wire barrel.

The above general description and the description below are exemplary and explanatory only and are not intended to limit the present disclosure.

### BRIEF DESCRIPTION OF THE DRAWINGS

One or more embodiments are illustrated by means of the corresponding drawings, which do not constitute a limitation of the embodiments, connection ports having the same reference numerals in the drawings are shown as similar connection ports, and the drawings do not constitute a limitation of proportion. In the drawings:

FIG. 1 is a schematic structure diagram of the hinge assembly provided by an embodiment of the present disclosure;

FIG. 2 is a schematic structure diagram of the hinge-track plate provided by the embodiment of the present disclosure;

FIG. 3 is a schematic structure diagram of the hinge plate provided by the embodiment of the present disclosure;

FIG. 4 is a schematic structure diagram of the hinge assembly provided by the embodiment of the present disclosure, illustrating the door body is in an open state;

FIG. 5 is another schematic structure diagram of the hinge provided by the embodiment of the present disclosure, illustrating the door body is in an open state;

FIG. 6 is another schematic structure diagram of the hinge assembly provided by the embodiment of the present disclosure, illustrating the door body is in an open state;

FIG. 7 is another schematic structure diagram of the hinge plate provided by the embodiment of the present disclosure;

FIG. 8 is a schematic structure diagram of the wire harness plate provided by the embodiment of the present disclosure;

FIG. 9 is a schematic structure diagram of the combination of the hinge plate and the wire harness plate provided by the embodiment of the present disclosure;

FIG. 10 is another schematic structure diagram of the hinge-track plate provided by the embodiment of the present disclosure;

FIG. 11 is another schematic structure diagram of the hinge-track plate provided by the embodiment of the present disclosure;

FIG. 12 is a schematic structure diagram of the combination of the hinge-track plate and the wire harness plate provided by the embodiment of the present disclosure;

FIG. 13 is a schematic structure diagram of the door-in-door refrigerator provided by the embodiment of the present disclosure;

FIG. 14 is a schematic diagram of the arrangement of the wire harness provided by the embodiment of the present disclosure;

FIG. 15 is a cross-sectional view of the secondary door hinge provided by the embodiment of the present disclosure;

FIG. 16 is a schematic structure diagram of the hinge shaft provided by the embodiment of the present disclosure;

FIG. 17 is a cross-sectional view of the hinge shaft provided by the embodiment of the present disclosure;

FIG. 18 is a schematic structure diagram of the hinge seat provided by the embodiment of the present disclosure;

FIG. 19 is a cross-sectional view of the hinge seat provided by the embodiment of the present disclosure; and FIG. 20 is a schematic structure diagram of another door-in-door refrigerator provided by the embodiment of the present disclosure.

### DETAILED DESCRIPTION OF THE EMBODIMENTS

In order to enable a more detailed understanding of the features and technical content of the embodiments of the present disclosure, the implementation of the embodiments of the present disclosure will be described in detail below in conjunction with the accompanying drawings, which are for illustration only and are not intended to limit the embodiments of the present disclosure. In the following technical description for convenience of explanation, several details are provided for a full understanding of the disclosed embodiments. However, one or more embodiments may still be practiced without these details. In other instances, the well-known structures and devices may simplify the disclosure in order to simplify the drawings.

The terms “first”, “second” and the like in the specification and claims of embodiments of the present disclosure and the above drawings are used to distinguish similar elements and are not necessarily used to describe a particular order or priority. It should be understood that the data used in this way can be interchanged where appropriate for the embodiments of the present disclosure described herein. Furthermore, the terms “comprise” and “have”, and any variations thereof are intended to cover a non-exclusive inclusion.

In embodiments of the present disclosure, directional or positional relationship indicated by terms such as “up”, “down”, “inside,” “middle”, “outside”, “front” and “rear” is based on the directional or positional relationship shown in the drawings. These terms are mainly intended to describe embodiments of the present disclosure, not to limit that the described devices, connection ports, or components must have a specific orientation or be configured and operated in a specific orientation. Furthermore, in addition to indicating the directional or positional relationship, the above partial terms might also be used to convey other meanings, for example, the term “on” might also be used to indicate a dependency relationship or connectional relationship in some cases. Those having ordinary skills in the art may understand specific meanings of these terms in the embodiments of the present disclosure according to specific situations.

In addition, the terms “dispose”, “connect” and “fix” should be understood in a broad sense. For example, “connect” may be fixed connection, detachable connection or integral connection, may be mechanical connection or electrical connection, may be direct connection, or indirect connection through an intermediate medium, or may be internal communication between two devices, connection ports, or components. Those having ordinary skills in the art may understand specific meanings of the above terms in the embodiments of the present disclosure according to specific situations.

Unless otherwise illustrated, the term “a plurality of” means two or more.

In the embodiment of the present disclosure, the character “/” indicates that the front element and rear element are in an “or” relationship. For example, A/B illustrates A or B.

The term “and/or” is an association relationship that describes elements, indicating that there can be three relationships. For example, A and/or B represent relationships: A or B, or A and B.

Embodiments of the present disclosure and features in the embodiments may be combined with one another without conflict.

A hinge assembly and a door-in-door refrigerator are provided by the embodiment of the present disclosure, providing more space for receiving a wire harness and avoiding the wear of the wire harness caused by some of the wire harnesses exposed to the outside.

In the first aspect, a hinge assembly 1 is provided by the embodiment of the present disclosure.

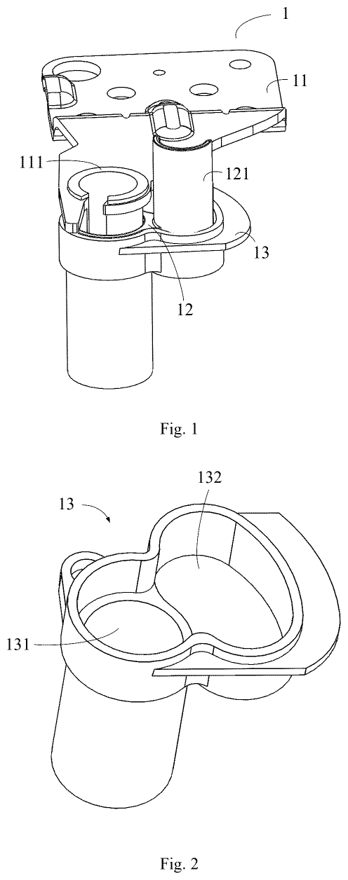

As shown in FIGS. 1 and 2, the hinge assembly 1 comprises a hinge plate 11, a wire harness plate 12, and a hinge-track plate 13.

The hinge plate 11 is disposed in a cabinet and provided with a first wire barrel 111 for receiving the wire harness. The wire harness plate 12 is provided with a second wire barrel 121 for receiving the wire harness. The hinge-track plate 13 is disposed in the door body and provided with a hinge slot 131 and a track slot 132. The hinge slot 131 is employed to receive the first wire barrel 111, the track slot 132 is employed to receive the second wire barrel 121, and the second wire barrel 121 is moveable within the track slot 132.

The hinge assembly 1 provided by the embodiment of the present disclosure realizes a rotatable connection between the door body and the cabinet through the cooperation of the hinge plate 11 and the hinge-track plate 13. The hinge plate 11 is provided with the first wire barrel 111 for receiving the wire harness and the wire harness plate 12 is provided with the second wire barrel 121 for receiving the wire harness, providing more space for receiving the wire harness and avoiding the wear of wire harness caused by some of the wire harnesses exposed to the outside. Furthermore, the second wire barrel 121 is disposed inside the track slot 132 and is moveable within the track slot 132. The door body can be opened at a large angle while the second wire barrel 121 rotates at a small angle. Therefore, opening and closing of the door body causes less pulling on the wire harness passed through the second wire barrel 121, reducing the wear on the wire harness passed through the second wire barrel 121.

The hinge assembly 1 realizes a rotatable connection between the door body and the cabinet through the cooperation of the hinge plate 11 and the hinge-track plate 13 as follows.

The hinge plate 11 is fixedly connected to the cabinet, and the hinge plate 11 is provided with the first wire barrel 111. The hinge-track plate 13 is fixedly connected to the door body, and the hinge-track 13 is provided with the hinge slot 131 and the track slot 132. The hinge slot 131 is employed to receive the first wire barrel 111, and the hinge slot 131 can rotate around the first wire barrel 111 as a rotation center. The hinge plate 11 and the hinge-track plate 13 are rotatably connected by the first wire barrel 111 inserted into the first hinge slot 131, further realizing the rotatable connection between the door body and the cabinet.

The hinge plate 11 is employed to connect the door body and the cabinet, and the motion range of the second wire barrel 121 can be limited.

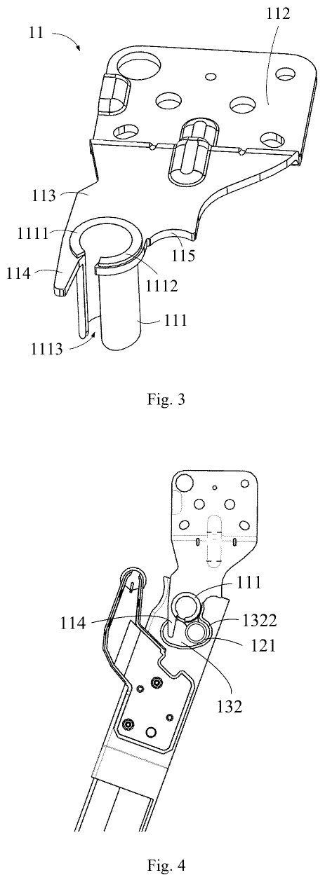

As shown in FIG. 3, the first end 112 of the hinge plate 11 is fixedly connected to the cabinet, and the second end 113 of the hinge plate 11 is provided with the first wire barrel 111. The first wire barrel 111 is adapted to pass into the hinge slot 131. Thus, the rotatable connection between the cabinet and the hinge-track plate 13 can be realized.

Optionally, as shown in FIG. 3, an extended edge is disposed on the top of the first wire barrel 111. By providing the extended edge, the first wire barrel 111 can be firmly fixed to the hinge plate 11, avoiding the first wire barrel 111 falling off from the hinge plate 11 under force.

Optionally, as shown in FIG. 3, a first opening 1113 is disposed on a side of the first wire barrel 111 away from the first end 112.

By providing the first opening 1113 disposed on the side of the first wire barrel 111 away from the first end 112, the wire harness is easy to pass into the first wire barrel 111.

Optionally, as shown in FIG. 3, the first wire barrel 111 comprises a first side 1111 and a second side 1112. Where the first side 1111 and the second side 1112 are opposite sides, and the first side 1111 is closer to the outside of the cabinet than the second side 1112 along the length of the cabinet.

The cabinet has a length, a width, and a height. In a case where the refrigerator is normally operating, the height of the cabinet is extended along a vertical direction, the width of the cabinet is a distance between a front panel and a rear panel, and the length of the refrigerator is a distance between two side walls of the refrigerator. The refrigerator has a cabinet opening, the surface where the cabinet opening is located is the front panel, and the rear panel is opposite to the front panel.

Optionally, as shown in FIG. 3, the hinge plate 11 is further provided with a first stop portion 114. The first stop portion 114 is disposed on the second end 113 of the hinge plate 11 and connected to the first side 1111 of the first wire barrel 111, and the first stop portion 114 is extended in a direction away from the first end 112.

By providing the first stop portion 114, the motion range of the second wire barrel 121 can be limited to an appropriate range. Thus, the pulling of the wire harness inside the second wire barrel 121 due to an excessively large motion range of the second wire barrel 121 can be avoided, and the collision between the second wire barrel 121 and a hinge box can also be avoided.

Optionally, as shown in FIG. 4, in a case where the opening angle of the door body is larger than or equal to a first preset angle, the second wire barrel 121 moves within the range limited by the first stop portion 114 and the track slot 132.

Thus, the motion range of the second wire barrel 121 can be limited to an appropriate range, avoiding pulling and wearing the wire harness due to an excessive rotation angle of the second wire barrel 121. Furthermore, the opening and closing of the door body are not affected and the opening angle of the door body is not reduced.

Optionally, the first stop portion 114 is in a straight line shape. Thus, the hinge assembly is easy to arrange.

Optionally, as shown in FIG. 3, the hinge plate 11 is further provided with a second stop portion 115. The second stop portion 115 is disposed on the second end 113 of the hinge plate 11 and connected to the second side 1112 of the first wire barrel 111, and the second stop portion 115 is extended at the length direction of the cabinet.

By providing the second stop portion 115, the motion range of the second wire barrel 121 can be limited to an appropriate range. Thus, the pulling of the wire harness inside the second wire barrel 121 due to an excessively large motion range of the second wire barrel 121 can be avoided, and the collision between the second wire barrel 121 and the hinge box can also be avoided.

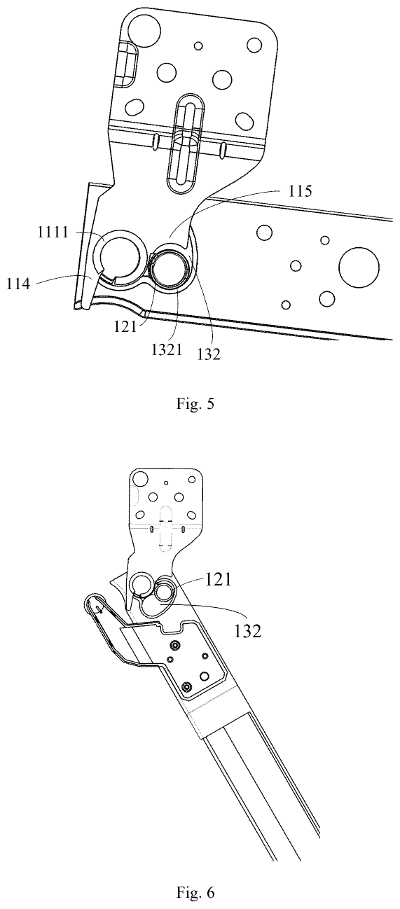

Optionally, as shown in FIG. 5, in a case where the opening angle of the door body is less than or equal to a second preset angle, the second wire barrel 121 moves within the range limited by the second stop portion 115 and the track slot 132.

Thus, the motion range of the second wire barrel 121 can be limited to an appropriate range, avoiding pulling and wearing the wire harness due to an excessive rotation angle of the second wire barrel 121. Furthermore, the opening and closing of the door body are not affected and the opening angle of the door body is not reduced.

Optionally, the second stop portion 115 is in an inwardly concaved arc shape. Thus, the hinge assembly is easy to arrange.

Optionally, as shown in FIG. 6, in a case where the opening angle of the door body is less than the first preset angle and larger than the second preset angle, the second wire barrel 121 moves within the range limited by the track slot 132.

Thus, the motion range of the second wire barrel 121 can be limited to an appropriate range, avoiding pulling and wearing the wire harness due to an excessive rotation angle of the second wire barrel 121.

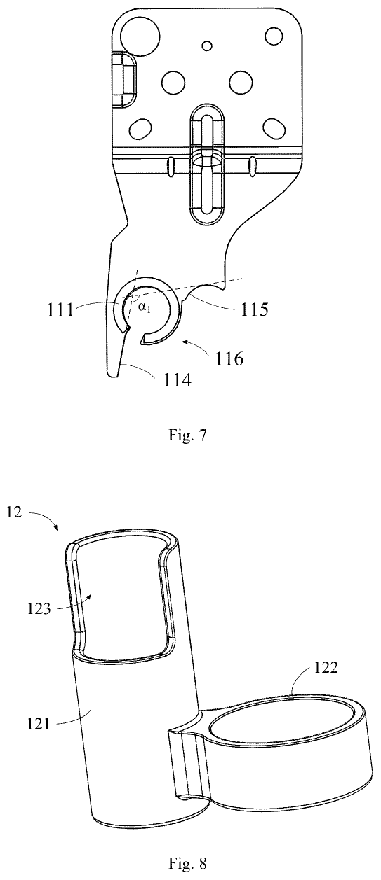

Optionally, as shown in FIG. 7, the first angle al is formed between an extended line of the first stop portion 114 and an outer tangent line of the second stop portion 115, and the first angle al has a range of 75°~125°. For example, the first angle al can be defined as 75°, 80°, 85°, 90°, 95°, 100°, 120°, or 125° and so on.

Optionally, the second wire barrel 121 can be rotated at a maximum angle which is less than or equal to the first angle al. It should be understood that the size of the external diameter of the second wire barrel 121 affects the maximum angle at which the second wire barrel 121 can be rotated. In a case where the external diameter of the second wire barrel 121 is close to zero, the maximum angle at which the second wire barrel 121 can be rotated is close to the first angle al.

Optionally, as shown in FIGS. 7 and 5, a limit notch 116 is formed and surrounded by the first stop portion 114, the second stop portion 115, and the hinge plate 11. The second wire barrel 121 is disposed in the limit notch 116 and rotates around the first wire barrel 111 as a rotation center within the range of the limit notch 116.

The wire harness plate 12 is provided with the second wire barrel 121 movable within the track slot 132, increasing the space for receiving the wire harness.

Optionally, as shown in FIG. 8, the second wire barrel 121 is provided with a second opening 123. Thus, the wire harness is easy to pass from the second wire barrel 121.

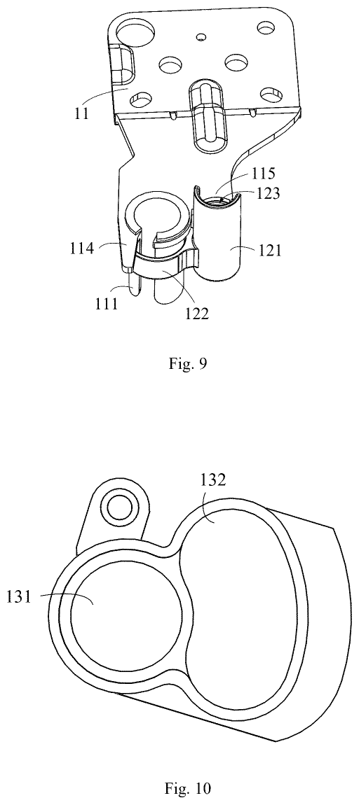

Optionally, as shown in FIGS. 8 and 9, the second opening 123 is disposed on the upper portion of the second wire barrel 121. In a case where the refrigerator door body is in a closed state, the second opening 123 is faced to the hinge plate 11. Thus, the wire harness is easy to pass into the cabinet through the second wire barrel 121.

Optionally, as shown in FIG. 9, the upper surface of the second wire barrel 121 is higher than the upper surface of the first stop portion 114 and the upper surface of the second stop portion 115.

Thus, in a case where the second wire barrel 121 rotates to the first stop portion 114 along a first direction, the second wire barrel 121 collides with the first stop portion 114, preventing the second wire barrel 121 from continuing to rotate in the first direction, so as to realize limiting the rotation of the second wire barrel 121 along the first direction. In a case where the second wire barrel 121 rotates to the second stop portion 115 along a second direction, the second wire barrel 121 collides with the second stop portion 115, preventing the second wire barrel 121 from continuing to rotate in the second direction, so as to realize limiting the rotation of the second wire barrel 121 along the second direction.

A direction in which the door body is opening is defined as the first direction and a direction in which the door body is closing is defined as the second direction.

Optionally, the external diameter of the second wire barrel 121 is 10 mm~18 mm. For example, the external diameter of the second wire barrel 121 is 14 mm.

Optionally, as shown in FIGS. 8 and 9, the wire harness plate 12 further comprises a first fixing component 122. The first fixing component 122 is sleeved on the first wire barrel 111, and the first fixing component 122 is fixedly connected to the second wire barrel 121.

By providing the first fixing component 122, the first fixing component 122 is sleeved on the first wire barrel 111 and fixedly connected to the second wire barrel 121, realizing the rotation of the second wire barrel 121 with the first wire barrel 111 as a rotation center.

Optionally, the first fixing component 122 is disposed on the lower portion of the second wire barrel 121.

The hinge-track plate 13 is employed to rotatably connect the door body to the hinge plate 11. Furthermore, the track slot 132 is provided for the second wire barrel 121 to limit the deflection angle of the second wire barrel 121.

Optionally, as shown in FIG. 10, the track slot 132 is in an arc shape. Thus, the motion space of the second wire barrel 121 within the track slot 132 can be ensured without taking too much space in the door body.

Optionally, a central angle α2 corresponding to the arc is in a range of 30°~60°, and the maximum angle that the door body can be opened is less than or equal to α1+α2. For example, the central angle α2 corresponding to the arc can be 30°, 35°, 45°, 50°, or 65°, and so on. As an example, the external diameter of the second wire barrel 121 is 14 mm, and the maximum angle at which the second wire barrel 121 can be rotated within the track slot 132 is 45°.

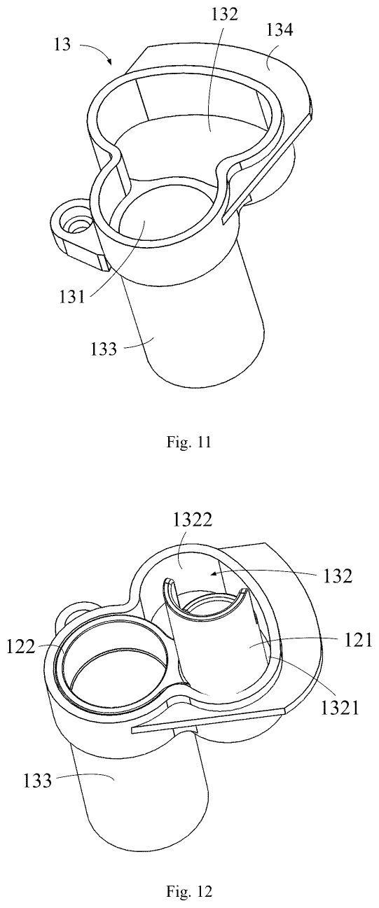

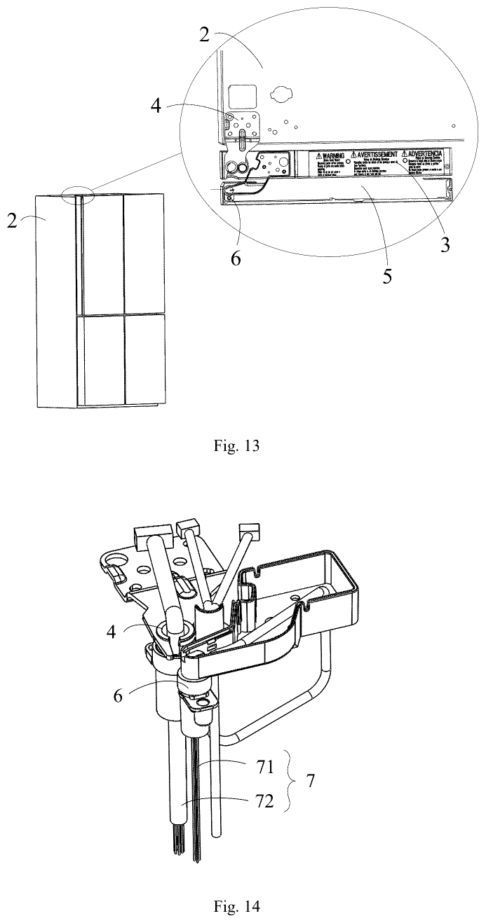

Optionally, as shown in FIG. 12, the track slot 132 comprises a first slot wall 1321 and a second slot wall 1322.

The first slot wall 1321 is disposed on one end of the track slot 132 and the second slot wall 1322 is disposed on the other end of the track slot 132. The second slot wall 1322 is employed to contact the side wall of the second wire barrel 121 to drive the second wire barrel 121 to move along the first direction, and the first slot wall 1321 is employed to contact the side wall of the second wire barrel 121 to drive the second wire barrel 121 to move along the second direction.

Optionally, as shown in FIG. 11, the hinge slot 131 is connected to the track slot 132, and the hinge slot 131 and the track slot 132 are formed in a gourd shape.

Thus, the hinge-track plate 13, the hinge plate 11, and the wire harness plate 12 can be easily cooperated and connected. Specifically, the first wire barrel 111 is disposed in the hinge slot 131, realizing the rotatable connection between the hinge-track plate 13 and the first wire barrel 111. The first fixing component 122 of the hinge plate 11 is disposed between the hinge slot 131 and the first wire barrel 111, and the second wire barrel 121 of the hinge plate 11 is disposed in the track slot 132, realizing the rotatable connection between the second wire barrel 121 and the first wire barrel 111 and limiting the motion range of the second wire barrel 121 within the track slot 132.

Optionally, as shown in FIG. 11, the hinge-track plate 13 further comprises a fixing barrel 133. The fixing barrel 133 is disposed on a lower portion of the hinge slot 131. The external diameter of the fixing barrel 133 is larger than the internal diameter of the hinge slot 131, and the internal diameter of the fixing barrel 133 is less than the internal diameter of the hinge slot 131.

The fixing barrel 133 forms a stepped shape at the lower portion of the hinge slot 131 and the first fixing component 122 is easily to be provided. Furthermore, by providing the fixing barrel 133, the wire harness can be limited and wire twisting and wearing caused by excessive wires in the wire harness can be reduced.

Optionally, as shown in FIG. 11, the hinge-track plate 13 further comprises a fixing plate 134. The fixing plate 134 is disposed on a side surface of the hinge-track plate 13 and disposed on an end away from the hinge slot 131.

By providing the fixing plate 134, the hinge-track plate 13 is easily fixedly connected to the door body.

It should be understood that a fixing slot is disposed in the door body to receive the fixing plate 134. By inserting the fixing plate 134 into the fixing slot, realizing the fixed connection between the hinge-track plate 13 and the door body.

The schematic diagram of the connection of the wire harness plate 12 and the hinge-track plate 13 is shown in FIG. 12, the track slot 132 rotates around a central axis of the first fixing component 122 as a rotation center, and the second wire barrel 121 rotates around the central axis of the first fixing component 122 as the rotation center within the track slot 132.

Optionally, the first wire barrel 111, the first fixing component 122, and the hinge slot 131 are sleeved in sequence from inner to outer. During the opening and closing of the door body, the first fixing component 122 rotates around the first wire barrel 111, and the second wire barrel 121 rotates around the first wire barrel 111 as the rotation center within the track slot 132.

Thus, the door body can be opened at a large angle, and the second wire barrel 121 can be opened at a small angle. Therefore, the opening and closing of the door body causes less pulling on the wire harness passed through the second wire barrel 121, reducing the wear on the wire harness passed through the second wire barrel 121.

Optionally, as shown in FIG. 4, in a case where the opening angle of the door body is larger than or equal to the first preset angle, the second wire barrel 121 moves within the range limited by the second slot wall 1322 and the first stop portion 114. As shown in FIG. 5, in a case where the opening angle of the door body is less than or equal to the second preset angle, the second wire barrel 121 moves within the range limited by the second slot wall 1321, and the second stop portion 115. As shown in FIG. 6, in a case where the opening angle of the door body is less than the first preset angle and larger than the second preset angle, the second wire barrel 121 moves within the range limited by the track slot 132.

Thus, the door body can be opened at a large angle (about α1+α2), and the second wire barrel 121 can rotate at a small angle (about α1). Therefore, the opening and closing of the door body causes less pulling on the wire harness passed through the second wire barrel 121, reducing the wear on the wire harness passed through the second wire barrel 121. In a case where the door body is thin, the second wire barrel 211 is newly added to provide more space for receiving the wire harness, avoiding the wire of the harness wear caused by some of the wire harnesses exposed to the outside.

In the second aspect, a door-in-door refrigerator is provided by the embodiment of the present disclosure.

As shown in FIGS. 13 and 14, the door-in-door refrigerator provided by the embodiment of the present disclosure comprises a cabinet 2, a main door 3, a main door hinge 4, a secondary door 5, a secondary door hinge 6, and a wire harness 7.

The cabinet 2 is provided with a cabinet opening and a control portion. The main door 3 is disposed on the cabinet 2 to close and open the cabinet opening, and the main door 3 is provided with a main door electric component. The main door hinge 4 is employed to rotatably connect the main door 3 to the cabinet 2, where the main door hinge 4 is the hinge assembly 1 provided by the first aspect. The secondary door 5 is disposed on the main door 3, and the secondary door 5 is provided with a secondary door electric component. The secondary door hinge 6 is employed to rotatably connect the secondary door 5 to the main door 3. The wire harness 7 comprises a secondary door wire harness 71 and a main door wire harness 72, the secondary door wire harness 71 is employed to connect the secondary door electric component to the control portion, and the main door wire harness 72 is employed to connect the main door electric component to the control portion. The secondary door wire harness 71 passes through the main door hinge 4 and the secondary door hinge 6, and the main door wire harness 72 passes through the main door hinge 4.

The control portion can control the cabinet 2 to control temperatures of the freezer compartment and/or the refrigerator compartment that are configured to store a food item. Specifically, the control portion can control at least one of a compressor, a damper, a valve and at least one fan to control the temperature of the cabinet 2 to control the temperature of the freezer compartment and/or the refrigerator compartment of the cabinet 2.

Though not illustrated, the control portion can comprise at least one processing unit and at least one memory. The processing unit may include a central processing unit (CPU), a graphics processing unit (GPU), a microprocessor, an application specific integrated circuit (ASIC), a field programmable gate array (FPGA), and the like, and can have a plurality of cores, for example. The memory can be volatile memory (e.g., RAM and the like), non-volatile memory (e.g., ROM, flash memory and the like) or a combination thereof. Additionally, the control portion can comprise an additional storage. The storage can comprise a magnetic storage, an optical storage, flash memory and the like but not be limited.

The door-in-door refrigerator provided by the embodiment of the present disclosure can realize the rotatable connection between the main door 3 and the cabinet 2 by the main door hinge 4. The main door hinge 4 is provided with the first wire barrel 111 and the second wire barrel 121 for receiving a wire harness, providing more arrangement space for the wire harness 7, and avoiding the wire of the harness wear caused by some of the wire harnesses exposed to the outside. Furthermore, the second wire barrel 121 is disposed in the track slot 132 and is moveable within the track slot 132, the main door 3 can be opened at a large angle, and the second wire barrel 121 rotates at a small angle. Therefore, the opening and closing of the main door 3 causes less pulling on the wire harness passed through the second wire barrel 121, reducing the wear on the wire harness passed through the second wire barrel 121.

Optionally, as shown in FIG. 14, the secondary door wire harness 71 passes through the secondary door hinge 6 from bottom to top, passes into the main door 3 from a top of the secondary door hinge 6, passes through the main door hinge 4 from bottom to top, passes into the cabinet 2 from a top of the main door hinge 4, and connects to the control portion. The main door wire harness 72 passes through the main door hinge 4 from bottom to top, passes into the cabinet 2 from the top of the main door hinge 4, and connects to the control portion.

Thus, the secondary door electric component and the control portion are easily connected by the secondary door wire harness 71, and the main door electric component and the control portion are easily connected by the main door wire harness 72.

Optionally, as shown in FIGS. 1 and 2, the main door hinge 4 comprises a hinge plate 11, a wire harness plate 12, and a hinge-track plate 13.

The hinge plate 11 is disposed on the cabinet, and the hinge plate 11 is provided with a first wire barrel 111 for receiving the wire harness. The wire harness plate 12 is provided with a second wire barrel 121 for receiving the wire harness. The hinge-track plate 13 is disposed on main door 3, where the hinge-track plate 13 is provided with the hinge slot 131 and the track slot 132, the hinge slot 131 is employed to receive the first wire barrel 111, the track slot 132 is employed to receive the second wire barrel 121, and the second wire barrel 121 is moveable within the track slot 132.

The secondary door wire harness 71 passes through the first wire barrel 111 and/or the second wire barrel 121 from bottom to top. The main door wire harness 72 passes through the first wire barrel 111 and/or the second wire barrel 121 from bottom to top.

Thus, the secondary door wire harness 71 and the main door wire harness 72 are easy to arrange. Furthermore, the second wire barrel 121 is disposed inside the track slot 132 and is moveable within the track slot 132, the main door 3 can be opened at a large angle, and the second wire barrel 121 rotates at a small angle. Thus, the length and the deflection angle of the secondary door wire harness 71 passing through the second wire barrel 121 and/or the main door wire harness 72 passing through the second wire barrel 121 required to be reserved is small. Therefore, the opening and closing of the main door 3 causes less pulling on the wire harness passed through the second wire barrel 121, reducing the wear on the wire harness passed through the second wire barrel 121.

Optionally, the track slot 132 is in an arc shape, and the second wire barrel 121 rotates around the first wire barrel 111 as a rotation center and eccentrically rotates with the arc track slot 132. The secondary door wire harness 71 and the main door wire harness 72 are provided with a predetermined length L, and the predetermined length L is employed to avoid pulling the secondary door wire harness 71 and the main door wire harness 72 caused rotating the main door 3.

The predetermined length L is provided to effectively avoid pulling the secondary door wire harness 71 and the main door wire harness 72 caused by rotating the main door 3, and reduce the wear on the secondary door wire harness 71 and the main door wire harness 72.

Optionally, the predetermined length L is in a range of L≥πR*A/360, where R is defined as a distance between an axis of the first wire barrel and an axis of the second wire barrel, and A is defined as a maximum deflection angle of the second wire barrel.

Thus, it is effective to avoid pulling the secondary door wire harness 71 and the main door wire harness 72 caused by rotating the main door 3, and reduce the wear on the secondary door wire harness 71 and the main door wire harness 72.

Optionally, as shown in FIG. 15, the secondary door hinge 6 comprises a hinge shaft 51 and a hinge seat 52. At least one surface of the hinge shaft 51 is provided with one or more first communication connection ports 511. Each first communication connection port 511 is employed to connect to the secondary door electric component in the secondary door 5. The hinge seat 52 is provided with a recess 521, the recess 521 is adapted to receive the hinge shaft 51, and at least one inner wall of the recess 521 is provided with one or more second communication connection ports 522. The second communication connection port 522 is employed to electronically connect to a terminal located at the outer side of the hinge seat 52, and the second communication connection port 522 corresponds to the first communication connection port 511 one-to-one. In a case where the hinge shaft 51 is inserted into the recess 521 and the hinge shaft 51 is relatively stationary and relatively rotated to the hinge seat 52, each first communication connection port 511 is connected to the corresponding second communication connection port 522 to realize communication.

Optionally, the secondary door wire harness 71 comprises a first sub-wire harness and a second sub-wire harness.

The first sub-wire harness is employed to connect the first communication connection port 511 to the secondary door electric component. The second sub-wire harness is employed to connect the second communication connection port 522 to the terminal located at the outer side of the hinge seat 52.

The first communication connection port 511 of the secondary door hinge 6 is connected to the secondary door electric component by the first sub-wire harness. The second communication connection port 522 of the hinge seat 52 is electronically connected to the terminal at the outer side of the hinge seat 52 by the second sub-wire harness. The hinge shaft 51 is inserted into the recess 521 of the hinge seat 52, realizing the connection and communication between the first communication connection port 511 and the second communication connection port 522, thus realizing the electrical connection between the secondary door electric component and the terminal during opening and closing the secondary door 5. The terminal does not need to pass through the secondary door hinge 6, thus the secondary door hinge 6 provided by the embodiment of the present disclosure makes it easy to realize the electrical connection between the terminal and the secondary door electric component.

One end of the hinge shaft 51 is fixedly connected to the door body of the refrigerator, and the other end of the hinge shaft 51 is rotatably connected to the hinge seat 52. The door body of the refrigerator can be rotatably fixed to the hinge seat 52 by the hinge shaft 51.

Optionally, the shape of the hinge shaft 51 comprises one or more of a cylinder, a cone, a frustum of a cone, a stepped cylinder, a stepped cone, and a frustum of a stepped cone.

By setting the shape of the hinge shaft to be one or more of a cylinder, a cone, a frustum of a cone, a stepped cylinder, a stepped cone, and a frustum of a stepped cone, the rotatable connection between the hinge shaft 51 and the hinge seat 52 can be easily realized. Thus, the rotatable connection between the door body of the refrigerator and the hinge seat 52 can be easily realized, and easy to open and close the door body of the refrigerator.

The shape of the hinge shaft 51 comprises one or more of a cylinder, a cone, a frustum of a cone, a stepped cylinder, a stepped cone, and a frustum of a stepped cone, in other words, the shape of the hinge shaft 51 can be a cylinder, a cone, a frustum of a cone, a stepped cylinder, a stepped cone, or a frustum of a stepped cone.

The shape of the hinge shaft 51 comprises more of a cylinder, a cone, a frustum of a cone, a stepped cylinder, a stepped cone, and a frustum of a stepped cone, in other words, the shape of the hinge shaft 51 can be any two, three, or more combinations of a cylinder, a cone, a frustum of a cone, a stepped cylinder, a stepped cone, or a frustum of a stepped cone. For example, the hinge shaft 51 is in a combination of a cylinder and a frustum of a cone shape. A frustum of a cone is disposed on the upper end surface of a cylinder, both the cylinder and the frustum of a cone are extended in a vertical direction, and a central line of the cylinder coincides with a central line of the frustum of a cone.

At least one surface of the hinge shaft 51 is provided with one or more first communication connection ports 511. In other words, one or more surfaces of the hinge shaft 51 are provided with the first communication connection port 511, and each surface can be provided with one or more first communication connection port 511.

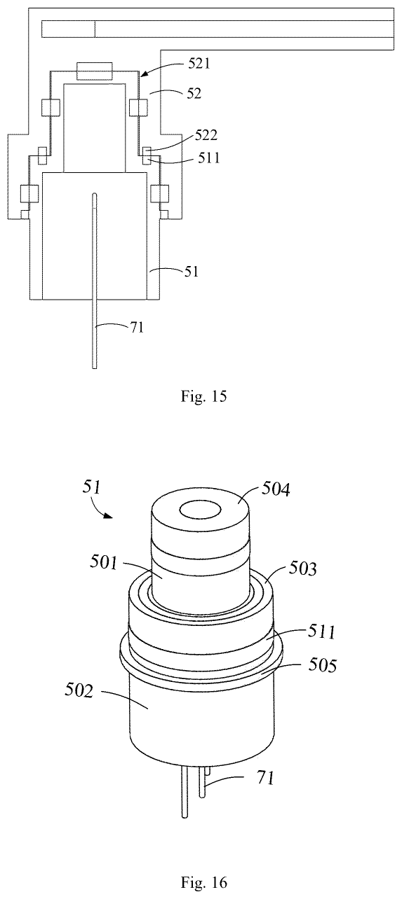

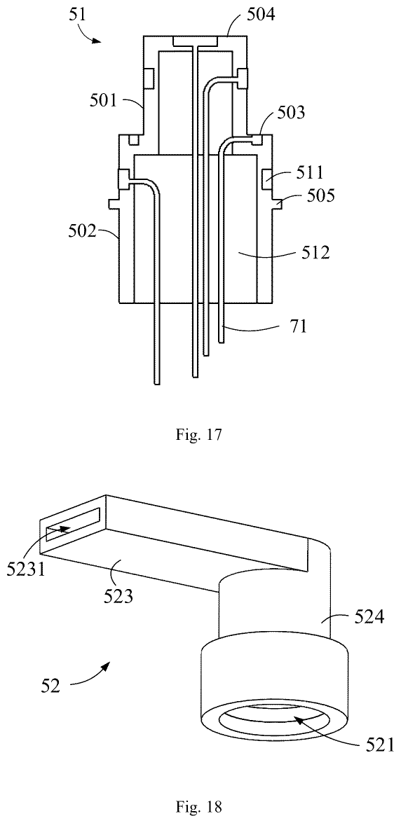

Optionally, as shown in FIGS. 16 and 17, the hinge shaft is in a first stepped cylinder shape. The first stepped cylinder at least comprises a first cylindrical surface 501, a second cylindrical surface 502, and a first stepped surface 503. The second cylindrical surface 502 is disposed below the first cylindrical surface 501, and a cross-section of the second cylindrical surface 502 is larger than a cross-section of the first cylindrical surface 501. The first stepped surface 503 connects the first cylindrical surface 501 and the second cylindrical surface 502. The first cylindrical surface 501, the second cylindrical surface 502, and the first stepped surface 503 are all provided with at least one first communication connection port 511.

By setting the shape of the hinge shaft 51 in the first stepped cylinder shape, the opening and closing of the secondary door 5 are not affected, and the arrangement area of the first communication connection port 511 is enlarged. The hinge shaft 51 can be provided with one or more steps. in a case where a large number of the secondary door electric components are provided, a sufficient number of the first communication connection port 511 can also be provided.

It should be understood that, the height of the first cylindrical surface 501, the width of the second cylindrical surface 502, and the width of the first stepped surface 503 are all adjustable. The width of the first stepped surface 503 is defined as the difference between the radius of the cylinder corresponding to the first cylindrical surface 501 and the radius of the cylinder corresponding to the second cylindrical surface 502.

Optionally, as shown in FIG. 16, the first stepped cylinder further comprises a first end surface 504. The first stepped cylinder is formed and surrounded by the first cylindrical surface 501, the second cylindrical surface 502, the first stepped surface 503, and the first end surface 504.

Furthermore, as shown in FIG. 16, the first cylindrical surface 501, the second cylindrical surface 502, the first stepped surface 503, and the first end surface 504 are all provided with one of the first communication connection port 511.

Optionally, each first communication connection port 511 is in an arc or a ring shape, embedded in a surface of the hinge shaft 51, each surface of the first communication connection port 511 is even with the surface of the hinge shaft 51 on which the first communication connection port 511 is disposed. Correspondingly, each second communication connection port 522 located in the hinge seat 52 is in an arc or a ring shape, embedded at an inner wall of the recess 521, and the surface of each second communication connection port 522 is even with the inner wall of the recess 521 on which the second communication connection port 522 is located.

By setting the first communication connection port 511 and the second communication connection port 522 corresponding to the first communication connection port 511 in an arc or a ring shape, in a case where the hinge shaft 51 is rotated relative to the hinge seat 52, the first communication connection port 511 can still be connected to the corresponding second communication connection port 522. Thus, the signal interruption caused by opening and closing the secondary door 5 of the refrigerator can be avoided. By setting the surface of the first communication connection port 511 to be even with the surface of the hinge shaft 51 on which the first communication connection port 511 is located and the surface of the second communication connection port 522 to be even with the inner wall of the recess 521 on which the second communication connection port 522 is disposed, the hinge shaft 51 is easy to inserted into the hinge seat 52. It is convenient to connect the first communication connection port 511 to the corresponding second communication connection port 522 to realize communication.

It should be understood that, the length of the arc can be adjusted according to the angle of rotation of the opening and closing the secondary door 5.

Optionally, as shown in FIG. 17, a first receiving cavity 512 is disposed inside the hinge shaft 51, and the first receiving cavity 512 is in an inverted step shape.

By setting the first receiving cavity 512 disposed inside the hinge shaft 51 in the inverted step shape, the secondary door electric component is easy to connect to the first communication connection port 511. Specifically, one end of the first sub-wire harness is connected to the secondary door electric component, the other end of the first sub-wire harness passes into the first receiving cavity 512, passes through the inner wall of the hinge shaft 51, and connects to the first communication connection port 511 of the hinge shaft 51.

Each of the first communication connection ports 511 is electrically connected to one or more electric connection ports.

Optionally, as shown in FIGS. 16 and 17, the hinge shaft 51 is further provided with a locating component 505. The locating component 505 is in an arc or a ring shape and disposed on the surface of the hinge shaft 51.

By providing the locating component 505, the position between the hinge shaft 51 and the secondary door 5 is easy to locate. It should be understood that, a locating slot is disposed in the secondary door 5, and an external diameter of the locating component 505 is larger than an internal diameter of the locating slot. One end of the hinge shaft 51 is adapted to pass into the locating slot. In a case where a part of the hinge shaft 51 passes into the locating slot, the locating component 505 contacts with the secondary door 5. Due to the external diameter of the locating component 505 being larger than the internal diameter of the locating slot, the hinge shaft 51 is limited not continuing into the locating slot, and the position between the hinge shaft 51 and the secondary door 5 is located.

Optionally, the material of the first communication connection port 511 can be aluminum or copper.

Both aluminum and copper have excellent electrical conductivity. By setting the material of the first communication connection port 511 as aluminum or copper, the first communication connection port 511 is connected to the second communication connection port 522 to realize signal transmission.

Optionally, the material of the hinge shaft 51 is polyoxymethylene.

Polyoxymethylene has the advantages of high strength, light mass, high hardness, high modulus, strong impact, self-lubricating effect during dynamic friction, no noise, high fatigue resistance, good creep resistance, small dielectric loss angle tangent, and high breakdown voltage. By setting the material of the hinge shaft 51 as polyoxymethylene, the hinge shaft 51 has the advantage of being durable, wear-resistant, and low noise during the opening and closing of the door body.

One end of the hinge seat 52 is rotatably connected to the hinge shaft 51, and the other end of the hinge seat 52 is fixedly connected to the main door 3 of the refrigerator by the second sub-wire harness. The hinge shaft 51 is rotatably fixed to the main door 3 of the refrigerator by the hinge seat 52.

The recess 521 is disposed in the hinge seat 52 and the recess 521 is adapted to receive the hinge shaft 51.

Optionally, the space shape limited by the recess 521 comprises one or more of a cylinder, a cone, a frustum of a cone, a stepped cylinder, a stepped cone, and a frustum of a stepped cone.

It should be understood that, the shape limited by the recess 521 is the same as the shape of the hinge shaft 51. The hinge shaft 51 is easy to pass into the recess 521, realizing the rotatable connection between the hinge shaft 51 and the hinge seat 52.

Optionally, at least one inner wall of the recess 521 is provided with one or more second communication connection ports 522. In other words, one or more inner walls of the recess 521 are provided with the second communication connection port 522, and each inner wall can be provided with one or more second communication connection ports 522.

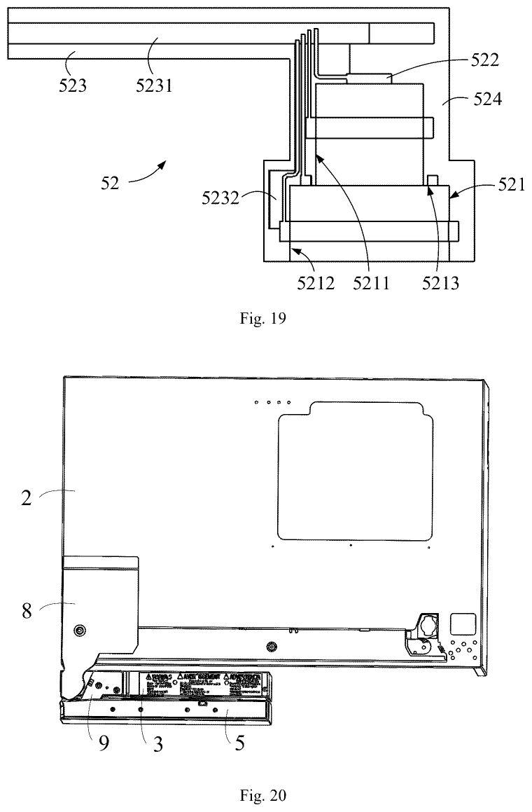

Optionally, as shown in FIG. 19, the space limited by the recess 521 is in a second stepped cylinder shape. The second stepped cylinder at least comprises a first cylindrical inner wall 5211, a second cylindrical inner wall 5212, and a first stepped inner wall 5213. The second cylindrical inner wall 5212 is disposed in the lower portion of the first cylindrical 5211 and the cross-section of the second cylindrical inner wall 5212 is larger than the cross-section of the first cylindrical inner wall 5211. The first stepped inner wall 5213 connects the first cylindrical inner wall 5211 and the second cylindrical inner wall 5212. The first cylindrical inner wall 5211, the second cylindrical inner wall 5212, and the first stepped inner wall 5213 are all provided with at least one of the second communication connection port 522.

Thus, the hinge shaft 51 is easy to insert into the recess 521, and in a case where the hinge shaft 51 is relatively stationary or relatively rotated to the hinge seat 52, each of the first communication connection port 511 is connected to the corresponding second communication connection port 522 to realize communication.

Optionally, each of the second communication connection port 522 is in a ring shape, embedded at the inner wall of the recess 521, and each surface of the second communication connection port 522 is even with the inner wall of the recess 521 on which the second communication connection port 522 is located. Correspondingly, each first communication connection port 511 is in a ring shape, embedded in the surface of the hinge shaft 51, and the surface of each of the first communication connection port 511 is even with the surface of the hinge shaft 51 on which the first communication connection port 511 is located.

Thus, the hinge shaft 51 is easy to insert into the hinge seat 52, and the first communication connection port 511 is connected to the corresponding second communication connection port 522 to realize communication. In a case where the hinge shaft 51 rotates relatively to the hinge seat 52, it still can be ensured that the first communication connection port 511 is connected to the corresponding second communication connection port 522.

Optionally, as shown in FIG. 18, the hinge seat 52 comprises a fixing portion 523 and a first connection portion 524.

The fixing portion 523 is extended along a horizontal direction. The first connection portion 524 is disposed on an end of the fixing portion 523, and an extension direction of the first connection portion 524 is perpendicular to an extension direction of the fixing portion 523. The recess 521 is disposed in the first connection portion 524.

By providing the fixing portion 523, it is easy to fixedly connect to the main door. By providing the first connection portion 524, it is easy to rotatably connect to the hinge shaft 51. The hinge shaft 51 is rotatably connected to the main door by the hinge seat 52, realizing the rotatable connection between the secondary door 5 and the main door 3.

Optionally, as shown in FIG. 19, a second receiving cavity 5231 is disposed inside the fixing portion 523, and the second receiving cavity 5231 is connected to the outside. The electrical wires connected to the second communication connection port 522 are passed through the second receiving cavity 5231 and connected to the terminal located at the outer side of the hinge seat 52.

By providing the second receiving cavity 5231, the second communication connection port 522 is easy to be electrically connected to the terminal located at the outer side of the hinge seat 52. Specifically, one end of the second sub-wire harness is connected to the second communication connection port 522, and the other end of the second sub-wire harness passes through the second receiving cavity 5231 and electrically connected to the terminal located at the outer side of the hinge seat 52.

Optionally, as shown in FIG. 19, one or more third receiving cavities 5232 is further provided inside the fixing portion 523, and each of the third receiving cavities 5232 is connected to the second receiving cavity 5231. By providing the third receiving cavity 5232, the second sub-wire harness is easy to pass into the second receiving cavity 5231.

Optionally, the material of the second communication connection port 522 can be aluminum or copper.

Both aluminum and copper have excellent electrical conductivity. By setting the material of the second communication connection port 522 as aluminum or copper, the second communication connection port 511 is connected to the second communication connection port 511 to realize signal transmission.

Optionally, the material of the hinge seat 52 is polyoxymethylene.

Polyoxymethylene has the advantages of high strength, light mass, high hardness, high modulus, strong impact, self-lubricating effect during dynamic friction, no noise, high fatigue resistance, good creep resistance, small dielectric loss angle tangent, and high breakdown voltage. By setting the material of the hinge shaft 51 as polyoxymethylene, the hinge seat 52 has the advantage of being durable, wear-resistant, and low noise in opening and closing of the door body.

Optionally, as shown in FIG. 20, the door-in-door refrigerator further comprises a secondary door hinge box 8 and a main door hinge box 9.

The secondary door hinge box 8 is disposed above the main door 3 and rotatable connected to the secondary door 5, and the secondary door hinge 6 is wrapped in the secondary door hinge box 8. The main door hinge box 9 is disposed above the cabinet 2 and rotatable connected to the cabinet 2, and the main door hinge 4 is wrapped in the main door hinge box 9.

The secondary door hinge 6 is wrapped in the secondary door hinge box 8 and the main door hinge 4 is wrapped in the main door hinge box 9, ensuring a uniform appearance of the door-in-door refrigerator. Thus, the secondary door hinge 6 and the main door hinge 4 avoid being exposed, to affect the overall effect of the door-in-door refrigerator.

Optionally, the secondary door wire harness 71 passes from an upper portion of the secondary door hinge 6 into the secondary door hinge box 8, passes from a lower portion of the secondary door hinge box 8 into the main door 3, passes from the inner of the main door 3 through the first wire barrel 111 and/or the second wire barrel 121 from bottom to top, passes from an upper portion of the main door hinge 4 into the main door hinge box 9, and thus passes from a lower portion of the main door hinge box 9 into the cabinet 2.

Thus, the space for receiving wire harnesses is expanded and the wire harnesses are avoided from being exposed. Furthermore, wires are easy to arrange, ensuring the uniform appearance of the door-in-door refrigerator and improving the overall effect of the door-in-door refrigerator.

Optionally, the main door wire harness 72 passes from the inner of the main door 3 through the first wire barrel 111 and/or the second wire barrel 121 from bottom to top, passes from the upper portion of the main door hinge 4 into the main door hinge box 9, and thus passes from the lower portion of the main door hinge box 9 into the cabinet 2.

Thus, the space for receiving wire harnesses is expanded and the wire harnesses avoid being exposed. Furthermore, wires are easy to arrange, ensuring the uniform appearance of the door-in-door refrigerator and improving the overall effect of the door-in-door refrigerator.

The above description and drawings sufficiently illustrate embodiments of the present disclosure to enable practice by those skilled in the art. Other embodiments may comprise structural and other modifications. Embodiments represent only possible variations. Unless explicitly required, individual parts and functions are optional, and the order of operation can vary. Portions and features of some embodiments may be included in or in place of portions and features of other embodiments. Embodiments of the present disclosure are not limited to the structures already described above and shown in the figures and are subject to various modifications and changes without departing from their scope. The scope of the present invention is defined by the attached claims.

1. A door-in-door refrigerator, comprising:
a cabinet, provided with a cabinet opening and a control portion;
a main door, disposed on the cabinet, to close or open the cabinet opening, wherein the main door is provided with a main door electric component;
a main door hinge, to rotatably connect the main door to the cabinet;
a secondary door, disposed on the main door, wherein the secondary door is provided with a secondary door electric component;
a secondary door hinge, to rotatably connect the secondary door to the main door; and
a wire harness, comprising a secondary door wire harness and a main door wire harness, wherein the secondary door wire harness is employed to connect the secondary door electric component to the control portion and the main door wire harness is employed to connect the main door electric component to the control portion;
wherein the secondary door wire harness passes through the main door hinge and the secondary door hinge, and the main door wire harness passes through the main door hinge.

2. The door-in-door refrigerator according to claim 1, wherein
the secondary door wire harness passes through the secondary door hinge from bottom to top, passes into the main door from a top of the secondary door hinge, passes through the main door hinge from bottom to top, and passes into the cabinet from a top of the main door hinge, to be connected to the control portion; and
the main door wire harness passes through the main door hinge from bottom to top, and passes into the cabinet from the top of the main door hinge, to be connected to the control portion.

3. The door-in-door refrigerator according to claim 2, wherein the main door hinge comprises:
a hinge plate, disposed in the cabinet, wherein the hinge plate is provided with a first wire barrel for receiving the wire harness;
a wire harness plate, provided with a second wire barrel for receiving the wire harness; and,
a hinge-track plate, disposed on the door body, wherein the hinge-track plate is provided with a hinge slot and a track slot, the hinge slot is employed to receive the first wire barrel, the track slot is employed to receive the second wire barrel, and the second wire barrel is moveable within the track slot;
wherein the secondary door wire harness passes through at least one of the first wire barrel and the second wire barrel from bottom to top, and the main door wire harness passes through at least one of the first wire barrel and the second wire barrel from bottom to top.

4. The door-in-door refrigerator according to claim 3, wherein
the track slot is in an arc shape, and the second wire barrel rotates around the first wire barrel as a rotation center and eccentrically rotates within the track slot; and
the secondary door wire harness and the main door wire harness are provided with a predetermined length L, and the predetermined length L is employed to avoid pulling the secondary door wire harness and the main door wire harness caused by rotating the main door.

5. The door-in-door refrigerator according to claim 4, wherein
the predetermined length Lis in a range of L≥πR*A/360;
wherein R is defined as a distance between an axis of the first wire barrel and an axis of the second wire barrel, and A is defined as a maximum deflection angle of the second wire barrel.

6. The door-in-door refrigerator according to claim 1, wherein the secondary door hinge comprises:
a hinge shaft, provided with one or more first communication connection ports on a surface of the hinge shaft; wherein the first communication connection ports are connected to the secondary door electric component; and
a hinge seat, provided with a recess; wherein the recess is adapted to receive the hinge shaft, and an inner wall of the recess is provided with one or more second communication connection ports, the second communication connection ports are electrically connected to a terminal located at an outer side of the hinge seat, and the second communication connection ports correspond to the first communication connection ports one-to-one;
wherein in a case where the hinge shaft is inserted into the recess, and the hinge shaft is relatively stationary and relatively rotated to the hinge seat, the first communication connection ports are connected to the second communication connection ports one-to-one to realize communication.

7. The door-in-door refrigerator according to claim 6, wherein the secondary door wire harness comprises:
a first sub-wire harness, to connect the first communication connection ports to the secondary door electric component; and
a second sub-wire harness, to connect the second communication connection ports to the terminal located at the outer side of the hinge seat.

8. The door-in-door refrigerator according to claim 1, further comprising:
a secondary door hinge box, disposed above the main door and rotatable connected to the secondary door, wherein the secondary door hinge is wrapped in the secondary door hinge box; and
a main door hinge box, disposed above the cabinet and rotatable connected to the cabinet, wherein the main door hinge is wrapped in the main door hinge box.

9. The door-in-door refrigerator according to claim 8, wherein
the secondary door wire harness passes from an upper portion of the secondary door hinge into the secondary door hinge box, passes from a lower portion of the secondary door hinge box into the main door, passes from an inside of the main door through at least one of the first wire barrel and the second wire barrel from bottom to top, passes from an upper portion of the main door hinge into the main door hinge box, and passes from a lower portion of the main door hinge box into the cabinet.

10. The door-in-door refrigerator according to claim 8, wherein
the main door wire harness passes from the inside of the main door through at least one of the first wire barrel and the second wire barrel from bottom to top, passes from the upper portion of the main door hinge into the main door hinge box, thus passes from the lower portion of the main door hinge box into the cabinet.

11. The door-in-door refrigerator according to claim 9, wherein
the main door wire harness passes from the inside of the main door through at least one of the first wire barrel and the second wire barrel from bottom to top, passes from the upper portion of the main door hinge into the main door hinge box, thus passes from the lower portion of the main door hinge box into the cabinet.

12. The door-in-door refrigerator according to claim 2, wherein the secondary door hinge comprises:
a hinge shaft, provided with one or more first communication connection ports on a surface of the hinge shaft; wherein the first communication connection ports are connected to the secondary door electric component; and
a hinge seat, provided with a recess; wherein the recess is adapted to receive the hinge shaft, and an inner wall of the recess is provided with one or more second communication connection ports, the second communication connection ports are electrically connected to a terminal located at an outer side of the hinge seat, and the second communication connection ports correspond to the first communication connection ports one-to-one;
wherein in a case where the hinge shaft is inserted into the recess, and the hinge shaft is relatively stationary and relatively rotated to the hinge seat, the first communication connection ports are connected to the second communication connection ports one-to-one to realize communication.

13. The door-in-door refrigerator according to claim 12, wherein the secondary door wire harness comprises:
a first sub-wire harness, to connect the first communication connection ports to the secondary door electric component; and
a second sub-wire harness, to connect the second communication connection ports to the terminal located at the outer side of the hinge seat.

14. The door-in-door refrigerator according to claim 3, wherein the secondary door hinge comprises:
a hinge shaft, provided with one or more first communication connection ports on a surface of the hinge shaft; wherein the first communication connection ports are connected to the secondary door electric component; and
a hinge seat, provided with a recess; wherein the recess is adapted to receive the hinge shaft, and an inner wall of the recess is provided with one or more second communication connection ports, the second communication connection ports are electrically connected to a terminal located at an outer side of the hinge seat, and the second communication connection ports correspond to the first communication connection ports one-to-one;
wherein in a case where the hinge shaft is inserted into the recess, and the hinge shaft is relatively stationary and relatively rotated to the hinge seat, the first communication connection ports are connected to the second communication connection ports one-to-one to realize communication.

15. The door-in-door refrigerator according to claim 14, wherein the secondary door wire harness comprises:
a first sub-wire harness, to connect the first communication connection ports to the secondary door electric component; and
a second sub-wire harness, to connect the second communication connection ports to the terminal located at the outer side of the hinge seat.

16. The door-in-door refrigerator according to claim 4, wherein the secondary door hinge comprises:
a hinge shaft, provided with one or more first communication connection ports on a surface of the hinge shaft; wherein the first communication connection ports are connected to the secondary door electric component; and
a hinge seat, provided with a recess; wherein the recess is adapted to receive the hinge shaft, and an inner wall of the recess is provided with one or more second communication connection ports, the second communication connection ports are electrically connected to a terminal located at an outer side of the hinge seat, and the second communication connection ports correspond to the first communication connection ports one-to-one;
wherein in a case where the hinge shaft is inserted into the recess, and the hinge shaft is relatively stationary and relatively rotated to the hinge seat, the first communication connection ports are connected to the second communication connection ports one-to-one to realize communication.

17. The door-in-door refrigerator according to claim 16, wherein the secondary door wire harness comprises:
a first sub-wire harness, to connect the first communication connection ports to the secondary door electric component; and
a second sub-wire harness, to connect the second communication connection ports to the terminal located at the outer side of the hinge seat.

18. The door-in-door refrigerator according to claim 5, wherein the secondary door hinge comprises:
a hinge shaft, provided with one or more first communication connection ports on a surface of the hinge shaft; wherein the first communication connection ports are connected to the secondary door electric component; and
a hinge seat, provided with a recess; wherein the recess is adapted to receive the hinge shaft, and an inner wall of the recess is provided with one or more second communication connection ports, the second communication connection ports are electrically connected to a terminal located at an outer side of the hinge seat, and the second communication connection ports correspond to the first communication connection ports one-to-one;
wherein in a case where the hinge shaft is inserted into the recess, and the hinge shaft is relatively stationary and relatively rotated to the hinge seat, the first communication connection ports are connected to the second communication connection ports one-to-one to realize communication.

19. The door-in-door refrigerator according to claim 18, wherein the secondary door wire harness comprises:
a first sub-wire harness, to connect the first communication connection ports to the secondary door electric component; and
a second sub-wire harness, to connect the second communication connection ports to the terminal located at the outer side of the hinge seat.

20. The door-in-door refrigerator according to claim 1, wherein the main door hinge comprises:
a hinge plate, disposed in the cabinet, wherein the hinge plate is provided with a first wire barrel for receiving the wire harness;
a wire harness plate, provided with a second wire barrel for receiving the wire harness; and,
a hinge-track plate, disposed on the door body, wherein the hinge-track plate is provided with a hinge slot and a track slot, the hinge slot is employed to receive the first wire barrel, the track slot is employed to receive the second wire barrel, and the second wire barrel is moveable within the track slot;
wherein the secondary door wire harness passes through at least one of the first wire barrel and the second wire barrel from bottom to top, and the main door wire harness passes through at least one of the first wire barrel and the second wire barrel from bottom to top.
